(19) United States
(12) Patent Application Publication
(10) Pub. No.: US 2023/0360535 A1
(43) Pub. Date: Nov. 9, 2023

(54) METHODS AND APPARATUS FOR PROVIDING A PLURALITY OF DELIVERIES IN A COMPARTMENT OF AN AUTONOMOUS DELIVERY VEHICLE

(71) Applicant: Nuro, Inc., Mountain View, CA (US)

(72) Inventors: Peter John Thomas Johnson, Seattle, WA (US); Robin Nicholas Hubbard, Portland, OR (US); Allen Weihua Liu, San Jose, CA (US); Jon Lau, Mountain View, CA (US)

(73) Assignee: Nuro, Inc., Mountain View, CA (US)

(21) Appl. No.: 18/301,062

(22) Filed: Apr. 14, 2023

Related U.S. Application Data
(60) Provisional application No. 63/339,035, filed on May 6, 2022.

(51) Int. Cl. G08G 1/00; B60W 50/14; B60P 3/00; B60W 60/00

(52) U.S. Cl. CPC G08G 1/20; B60W 50/14; B60P 3/007; B60W 60/00256; B60W 2050/146; B60W 2420/42

(57) ABSTRACT

According to one aspect, a vehicle includes a chassis, a propulsion system carried on the chassis and configured to propel the vehicle; a control system supported by the chassis, at least one compartment supported by the chassis, and at least one configurable divider arrangement contained within the at least one compartment. The control system is configured to enable the vehicle to operate autonomously. The at least one configurable divider arrangement is arranged to define at least a first location, wherein the at least one configurable divider arrangement includes a sensor system and a notification system, the sensor system being arranged to detect a presence of an item at the first location, the notification system being arranged to provide an indication relating to the first location.

### PRIORITY CLAIM

This patent application claims the benefit of priority under 35 U.S.C. § 119 to U.S. Provisional Patent Application No. 63/339,035, filed May 6, 2022, and entitled “METHODS AND APPARATUS FOR PROVIDING A PLURALITY OF DELIVERIES IN A COMPARTMENT OF AN AUTONOMOUS DELIVERY VEHICLE”, which is incorporated herein by reference in its entirety.

### TECHNICAL FIELD

The disclosure relates to autonomous vehicles. More particularly, the disclosure relates to enabling goods such as packages, food, and/or groceries to be efficiently delivered and received in compartments of an autonomous vehicle.

### BACKGROUND

Autonomous delivery vehicles may be used to deliver goods, e.g., packages, to customers or intended recipients of the packages. To enable delivery vehicles to be deployed efficiently, each delivery vehicle may be scheduled to make more than one delivery and/or pickup during a single deployment. That is, a delivery vehicle may carry deliveries for multiple customers at substantially the same time.

When an autonomous delivery vehicle is deployed on a mission to complete deliveries to multiple customers, there is typically no human operator of the vehicle who may facilitate the retrieval of delivered items by the customers. As such, the ability to organize deliveries within an autonomous delivery vehicle such that customers may be able to readily identify their deliveries, or where to load pickups, and to efficiently configure the autonomous vehicle as needed to transport the deliveries, is becoming increasingly important.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a process flow diagram which illustrates a method of utilizing a divider arrangement in accordance with an embodiment.

FIG. 5 is a process flow diagram which illustrates a method of tracking packages and associated spaces, e.g., cubbies, defined by a divider arrangement in accordance with an embodiment.

FIGS. 6A-C are a process flow diagram which illustrates a method of completing a delivery to a customer in a compartment that includes spaces defined by a divider arrangement accordance with an embodiment.

FIG. 7 is a process flow diagram which illustrates a method of deploying a divider arrangement, e.g., step 413 of FIG. 4, in accordance with an embodiment.

FIG. 8 is a block diagram representation of a divider arrangement, e.g., divider arrangement 328 of FIG. 3, in accordance with an embodiment.

FIG. 9A is a block diagram representation of a divider arrangement in a compartment at a time t1 at which the divider arrangement is in an undeployed configuration in accordance with an embodiment.

FIG. 9B is a block diagram representation of a divider arrangement in a compartment, e.g., divider arrangement 928 in compartment 902 of FIG. 9A, at a time t2 at which the divider arrangement is in a first deployed configuration in accordance with an embodiment.

FIG. 9C is a block diagram representation of a divider arrangement in a compartment, e.g., divider arrangement 928 in compartment 902 of FIG. 9B, at a time t3 at which the divider arrangement is in a second deployed configuration in accordance with an embodiment.

FIG. 10A is a diagrammatic representation of a divider arrangement in a compartment in an undeployed configuration in accordance with an embodiment.

FIG. 10B is a diagrammatic representation of a divider arrangement in a compartment, e.g., divider arrangement that includes partitions 1042a-c in compartment 1002 of FIG. 10A, in a first deployed configuration in accordance with an embodiment.

FIG. 10C is a diagrammatic representation of a divider arrangement in a compartment, e.g., divider arrangement that includes partitions 1042a-c in compartment 1002 of FIG. 10A, in a second deployed configuration in accordance with an embodiment.

FIG. 11A is a diagrammatic representation of a retractable divider arrangement in a compartment in an undeployed configuration in accordance with an embodiment.

FIG. 11B is a diagrammatic representation of a retractable divider arrangement in a compartment, e.g., retractable divider arrangement that includes partitions 1142a, 1142b in compartment 1102 of FIG. 11A, in a first deployed configuration in accordance with an embodiment.

FIG. 11C is a diagrammatic representation of a retractable divider arrangement in a compartment, e.g., retractable divider arrangement that includes partitions 1142a, 1142b in compartment 1102 of FIG. 11A, in a second deployed configuration in accordance with an embodiment.

FIG. 12 is a block diagram representation of a divider arrangement, e.g., divider arrangement 328 of FIG. 3, that includes a configurable divider arrangement in accordance with an embodiment.

FIG. 13A is a diagrammatic representation of a vehicle with compartments that are configured to include configurable divider arrangements in accordance with an embodiment.

FIG. 13B is a diagrammatic representation of a vehicle, e.g., vehicle 1301 of FIG. 13A, that shows a first delivery spot that may be substantially highlighted in accordance with an embodiment.

FIG. 13C is a diagrammatic representation of a vehicle, e.g., vehicle 1301 of FIG. 13A, that shows a second delivery spot that may be substantially highlighted in accordance with an embodiment.

FIG. 13D is a diagrammatic representation of a vehicle, e.g., vehicle 1301 of FIG. 13A, that shows an alternate configuration of a configurable partition arrangement, e.g., configurable partition arrangement 1342b of FIG. 13A, in accordance with an embodiment.

FIG. 14 is a process flow diagram which illustrates a method of a customer obtaining a delivery from a vehicle with a compartment which includes a smart divider arrangement in accordance with an embodiment.

FIG. 15 is a process flow diagram which illustrates a method of a customer providing an item, as for example a return item or a parcel, to a compartment of a vehicle which includes a smart divider arrangement in accordance with an embodiment.

### DESCRIPTION OF EXAMPLE EMBODIMENTS

### General Overview

In one embodiment, a vehicle includes a chassis, a propulsion system carried on the chassis and configured to propel the vehicle; a control system supported by the chassis, at least one compartment supported by the chassis, and at least one configurable divider arrangement contained within the at least one compartment. The control system is configured to enable the vehicle to operate autonomously. The at least one configurable divider arrangement is arranged to define at least a first location, wherein the at least one configurable divider arrangement includes a sensor system and a notification system, the sensor system being arranged to detect a presence of an item at the first location, the notification system being arranged to provide an indication relating to the first location.

According to another embodiment, an apparatus includes a configurable partition arrangement, an interface, a sensor system, and a notification system. The configurable partition arrangement has at least one deployed configuration and a retracted configuration, wherein the configurable partition arrangement is arranged to define at least a first location when in the at least one deployed configuration. The interface includes a connection configured to couple the configurable partition arrangement to a vehicle. The sensor system detects a presence of an item at the first location, and the notification system provides an indication that identifies the first location.

In accordance with still another embodiment, a method includes supporting a first item at a first location defined in a configurable divider arrangement when the configurable divider arrangement is in a first orientation. The configurable divider arrangement is arranged in a first compartment on a vehicle. The method also includes providing access to the first compartment, and providing, using a notification system included in the first compartment, a first indication of the first location. A determination is made as to when the first item is removed from the first location, and when it is determined that the first item is removed from the first location, a delivery is considered to be completed.

A smart divider arrangement may be positioned in a compartment of a vehicle such as an autonomous delivery vehicle, and may include one or more partitions which may be deployed in different configurations to enable an interior of the compartment to be customized to accommodate different types of goods. The smart divider arrangement may be arranged to define spaces into which goods, e.g., packages, may be placed, and may further be arranged to identify which space a particular package is located in. The information relating to which space within a compartment, as substantially defined by the smart divider arrangement, contains a particular package may be provided to a recipient of the particular package, and may also be used to provide an indication to the recipient when the recipient accesses the compartment to retrieve his or her package. The location at which a particular package is to be loaded may also be indicated.

### DESCRIPTION

To deploy fleets of vehicles, e.g., fleets of autonomous vehicles, in an efficient manner, the ability to relatively quickly configure delivery compartments of vehicles and the ability to enable deliveries to readily be retrieved from the compartments is important. The ability to relatively quickly configure a compartment of a vehicle allows for the efficient deployment of the vehicle to complete one or more deliveries or pickups. The ability to facilitate the retrieval of a delivery from a compartment of vehicle enables customers to efficiently interact with the vehicle.

By providing a configurable partition or divider arrangement in a compartment of a delivery vehicle, the layout of individual spaces into which goods may be placed for delivery may be readily modified. The configuration of spaces or slots intended to accommodate individual goods, e.g., packages, may be substantially customized using the divider arrangement. The divider arrangement may have an undeployed configuration in which the divider arrangement is effectively folded against or otherwise retracted against a wall, as for example a floor, a ceiling, or a side, of a compartment, and one or more deployed configurations in which the divider arrangement is unfolded or unfurled to essentially define one or more separate spaces which may hold goods intended for different recipients.

A divider arrangement used in a compartment of a vehicle may be a smart divider arrangement. That is, a divider arrangement may include hardware and/or software configured to enable divider arrangement to collect and/or to distribute information relating to goods carried in a compartment. For example, a divider arrangement may include sensors arranged to collect information relating to a package and which space the package is located in, as well as indicators configured to essentially inform a recipient of which space holds his or her package. Sensors that collect information relating to a package may also detect a package size, and cause the package size to be provided to a fleet management system such that a cargo size may be processed for purposes of planning future deliveries. The information relating to a package may include, but is not limited to including, the identity of a recipient of the package, dimensions of the package, and/or a weight of the package. Indicators may generally include, but are not limited to including, visual indicators such as lights and/or audio indicators such as speakers. It should be appreciated, however, that a divider arrangement may use hardware and/or software otherwise located on an autonomous vehicle to collect and to distribute information relating to goods carried in a compartment.

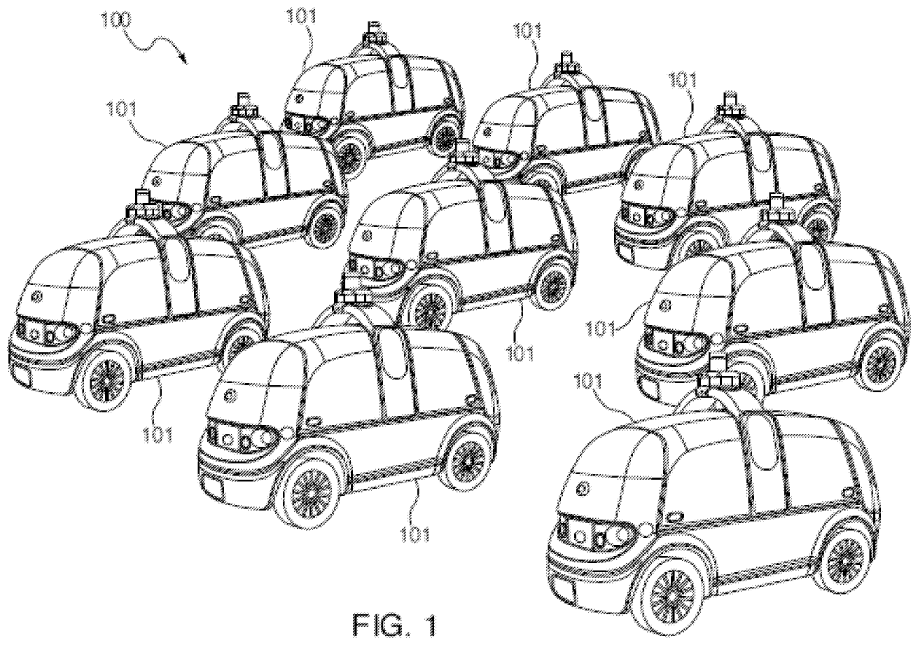

Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

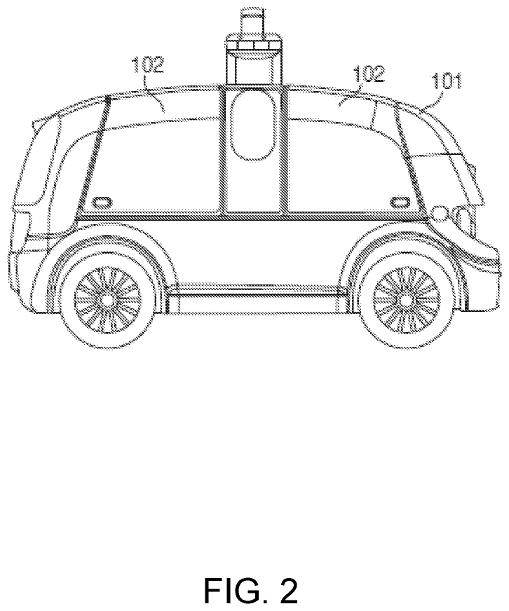

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

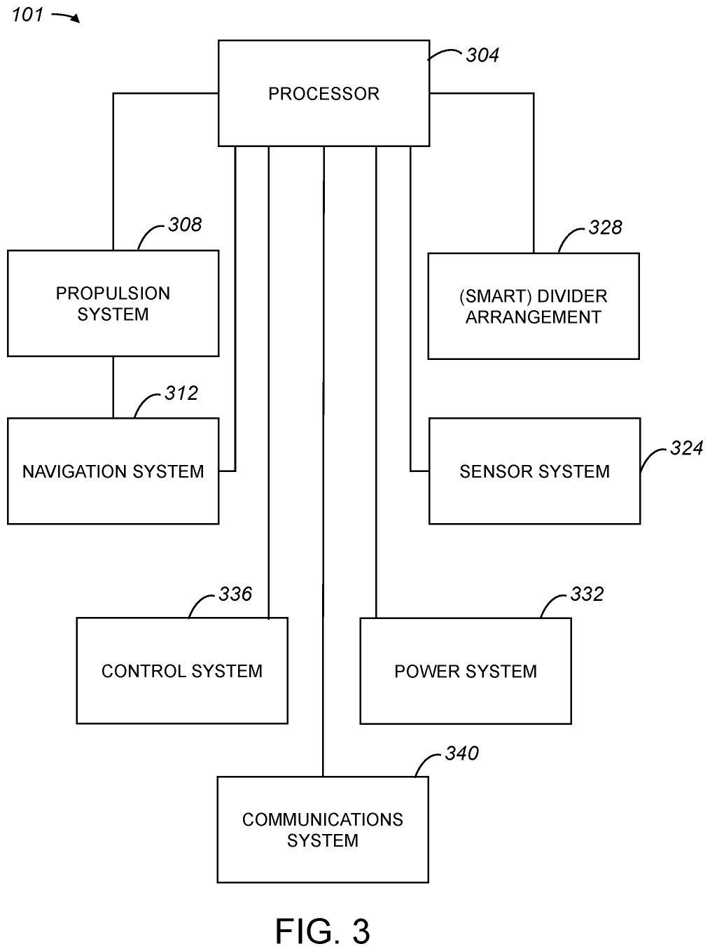

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, a communications system 340, and a divider arrangement 328, which may be a smart divider arrangement. It should be appreciated that processor 304, propulsion system 308, navigation system 312, sensor system 324, power system 332, communications system 340, and divider arrangement 328 are all coupled to, or otherwise supported on, a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

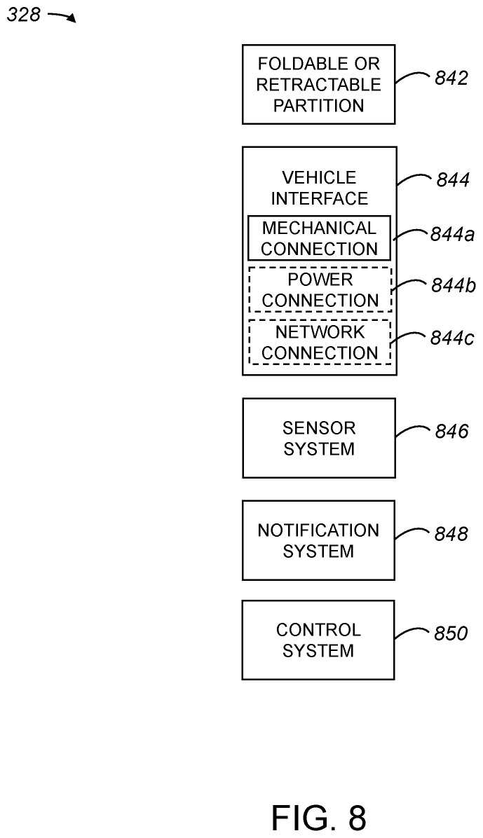

Divider arrangement 328 is generally configured to be positioned in a compartment, e.g., compartment 102 as shown in FIGS. 1 and 2, and may include both hardware and software components. Hardware components may include mechanical shelves or other structures configured to enable a compartment to be substantially partitioned, as for example into one or more cubbies or storage slots. Hardware components may also include sensors and indicators. Sensors may include, but are not limited to including, one or more weight sensors configured to determine weights of packages in cubbies defined within divider arrangement 328, one or more cameras configured to capture images of packages and cubbies, and/or one or more scanners configured to scan bar codes and/or QR codes on packagers. It should be appreciated that some sensors associated with divider arrangement 328 may generally be included in sensor system 324, although other sensors may be part of divider arrangement 328. Indicators may include, but are not limited to including, one or more lights configured to be activated to provide a visual signal to a customer or package recipient of which location his or her package is located in, and/or one or more audio arrangements configured to provide an audio indication to signal a customer or package recipient of which receptacle, e.g., cubby or spot, his/her package is located in. It should be appreciated that an audio indication may be provided by way of a text-to-speech conversion. Software components may include computer logic configured to associate packages with cubbies, as well as to provide associations of packages with cubbies to a management system and/or customers or intended recipients of the packages. One embodiment of divider arrangement 328 will be discussed below with reference to FIG. 8.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand. In one embodiment, communications system 340 may provide information related to a good carried on autonomous vehicle, as for example a package in a space defined by a divider arrangement, to a cloud-based fleet management system which may then communicate with a sender or a recipient of a package via a network using electronic communications.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

Compartments of an autonomous vehicles, e.g., compartments 102 of autonomous vehicle 101 of FIG. 2, may be arranged to transport deliveries to customers. The interiors of compartments may be configured based upon the type of goods carried in compartments. Some deliveries may be accommodated, for example, by shelves or sections defined by a divider arrangement. It should be appreciated that pickups, as for example pickups of packages from a customer that are to be delivered to a shipping hub, may also be accommodated by shelves or sections defined by the divider arrangement.

A divider or partitioning arrangement, e.g., a smart divider arrangement, may be used to facilitate configuring an overall interior space of a compartment such as compartment 102 of FIG. 2. A divider arrangement may be positioned within a compartment such that in an undeployed state, the divider arrangement is effectively stored against a surface or wall of the compartment. In a deployed state, the divider arrangement may cooperate with at least one wall of a compartment, and/or with another divider arrangement, to substantially define discrete spaces that may effectively hold goods for delivery. The discrete spaces may be slots, sections, cubbies, cubbyholes, nooks, niches, openings, etc. into which an item or good such as a package may be placed.

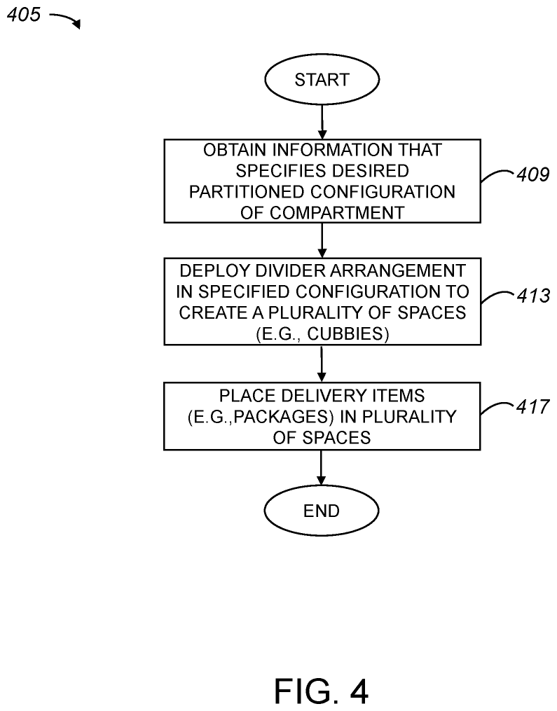

FIG. 4 is a process flow diagram which illustrates a method of utilizing a divider arrangement in accordance with an embodiment. A method 405 of utilizing a divider arrangement begins at a step 409 in which information that specifies a desired partitioned configuration of a compartment of a vehicle is obtained. The information may be obtained from a fleet management system, and may specify a desired partitioned configuration based upon items that the vehicle is to deliver. For example, if a vehicle is to be used to deliver packages, the desired partitioned configuration may be specified based on the dimensions of the packages to be delivered. The desired partitioned configuration may also be specified based on other considerations which may include, but are not limited to including, the weights of packages, the types of items contained within the packages, the access needs of a user such as a package recipient, and/or the preferences of the user.

In a step 413, the divider arrangement is deployed in the specified configuration to define or to otherwise create one or more separate spaces, e.g., cubbies. Deploying the divider arrangement may include unfolding, unfurling, unrolling, and/or positioning parts of the divider arrangement within the compartment of the vehicle. In one embodiment, when the divider arrangement is in an undeployed state, the divider arrangement may effectively be folded or compressed against a wall or a floor of the compartment. Deploying the divider arrangement may include securing the divider arrangement after unfolding the divider arrangement. Securing the divider arrangement may include, but is not limited to including, attaching the divider arrangement to a surface of the compartment using one or more fasteners, e.g., a hook that engages a receptacle or protrusion.

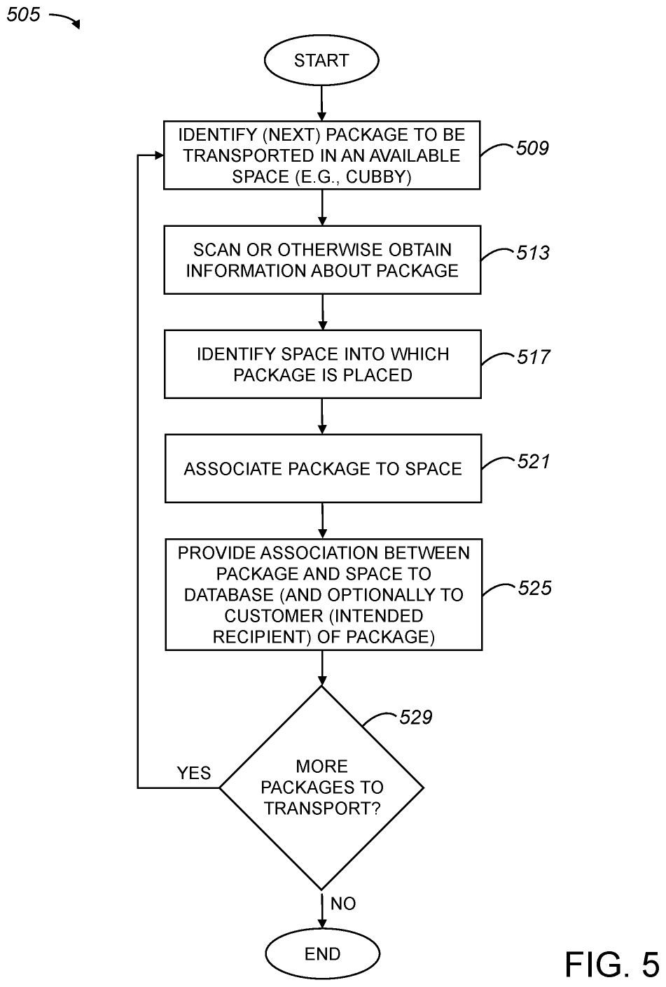

Once the divider arrangement is deployed, delivery items such as packages may be placed in the defined spaces in a step 417. Packages may generally be placed in spaces which have dimensions that accommodate the package. As will be discussed below, as for example with respect to FIG. 5, information which identifies the space in which each particular package is placed may be obtained. After the delivery items are placed in the defined spaces, the method of utilizing a divider arrangement is completed.

FIG. 5 is a process flow diagram which illustrates a method of tracking packages and associated spaces defined by a divider arrangement in a compartment of a vehicle in accordance with an embodiment. A method 505 of tracking packages and associated spaces defined by a divider arrangement begins at a step 509 in which a package that is to be transported in an available space is identified. Upon identifying the package, the package is scanned, or information about the package is otherwise obtained in a step 513. A shipping label on the package may be scanned, for example, using a sensor such as a camera or a bar code scanner, to identify the package. In one embodiment, identifying the package may include scanning the package using a sensor such as a camera mounted on the vehicle to effectively collect information about the package. In another embodiment, a fleet management system may obtain information relating to the recipient of the package using a sensor associated with the divider arrangement. For example, the divider arrangement may obtain information about the package and provide it to a fleet management system. As previously mentioned, sensors associated with a divider arrangement may include information about a package such as a weight of the package, a size or dimensions of the package, a sender of the package, and/or a recipient the package.

After information about the package is obtained, the space into which the package is placed is identified in a step 517. The space may be identified using any suitable method. By way of example, the space may be identified when the package is substantially automatically scanned by a sensor associated with the space, or when a camera mounted on the vehicle captures images which depict the space into which the package is being placed.

In a step 521, the package is effectively associated with the space. Associating the package with the space may include, but is not limited to including, creating a mapping that identifies the package as being positioned within the space. It should be appreciated that such a mapping enables a customer or an intended recipient of the package to be provide with information that indicates where the package is located within the vehicle compartment.

The association between a package and a space is provided to a database in a step 525. The database is generally associated with a fleet management system. In one embodiment, the customer or intended recipient of the package may also be provided with the association between the package and the space. For example, the vehicle or the fleet management system may cause a notification to be sent to the customer to notify the customer of which space his or her package is substantially contained in.

From step 525, process flow moves to a step 529 in which a determination is made as to whether there are more packages to transport. If the determination is that there are more packages to transport, process flow returns to step 509 in which the next package to be transported in an available space is identified. Alternatively, if it is determined in step 529 that there are no more packages to transport, the method of tracking packages and associated spaces defined by a divider arrangement is completed.

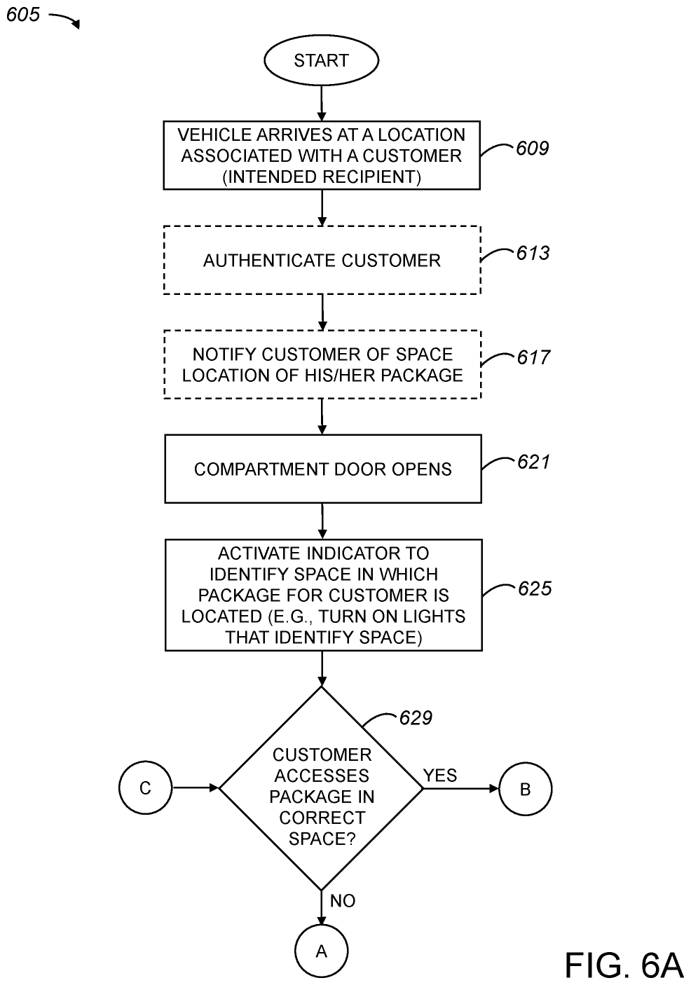

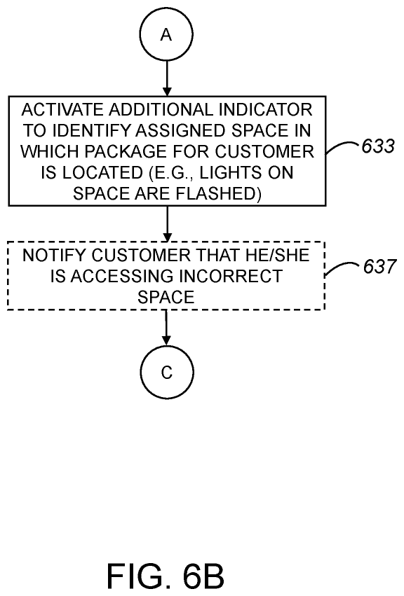

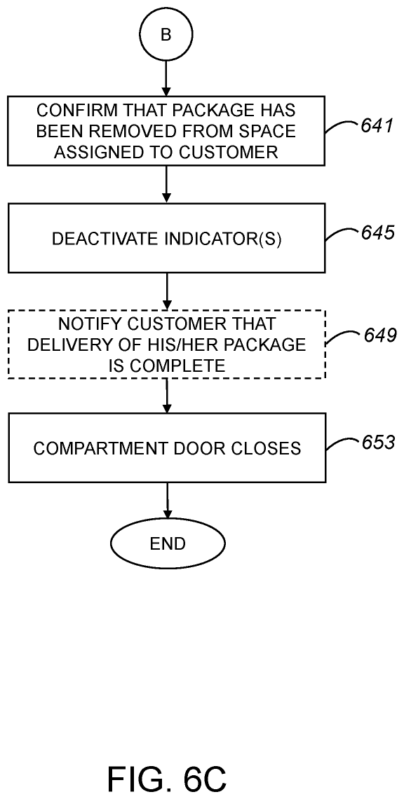

Referring next to FIGS. 6A-C, a method of completing a delivery to a customer using a vehicle with a compartment that includes spaces defined by a divider arrangement will be described in accordance with an embodiment. A method 605 of completing a delivery to a customer begins at a step 609 in which a vehicle arrives at a location associated with a customer, e.g., an intended recipient. The vehicle includes at least one compartment with substantially discrete spaces defined by a divider arrangement,

In an optional step 613, the customer is authenticated. That is, it is determined whether the customer is who he or she purports to be. Such a determination may be made through an interaction between the customer and the vehicle, and/or between the customer and a fleet management system that is in communication with the vehicle.

In an optional step 617, the customer is notified of the space location of his or her package. For example, the customer may be notified via a message sent to him or her on a computing device and/or a cellular phone, or the customer may be notified on a display screen or human machine interface (HMI) on the vehicle. It should be appreciated that other types of notifications may be used to communicate the space location of a package to a customer. Other types of notifications may include, but are not limited to including, audio instructions provided through a speaker associated with the vehicle.

The compartment door opens in a step 621, and in a step 625, an indicator is activated to identify the space in which the package for the customer is located. The indicator may be a light associated with the space that is turned on to indicate that the package is in that space. In one embodiment, the indicator may be one or more lights of an array of lights on a back wall of a compartment that may be selectively activated to substantially illuminate the space in which the package for the customer is located. It should be appreciated that indications may generally be provided using any suitable visible or audible signal.

From step 625, process flow proceeds to a step 629 in which it is determined whether the customer is accessing the package in the correct space. That is, a determination is made as to whether the customer is attempting to retrieve the package intended for the customer. Sensors such as cameras and weight sensors may be used to determine whether the customer is attempting to remove his or her intended package. It should be appreciated that cameras and weight sensors, in addition to other sensors, may be used to enable a computer vision or perception system to determine the actions of the customer.

If it is determined that the customer is not accessing the package in the correct space, the implication is that the customer is attempting to remove a package not intended for him or her. Accordingly in a step 633, an additional indicator is activated to identify the assigned or correct space in which the package for the customer is located. Such an additional indicator may indicate to the customer which space is the correct space. By way of example, individual lights of an array of lights on a wall of the compartment that are activated to substantially illuminate the correct space may be flashed and/or brightened to essentially provide a notification to the customer. In addition to the use of lights, audio cues such as audibly articulated directions may be provided to essentially highlight the correct space.

In an optional step 637, the customer may be notified that he or she is accessing a package not intended for him or her. That is, the customer may optionally be notified that he or she is accessing an incorrect space or a space that is not assigned to him or here. Such a notification may include, but is not limited to including, a vehicle or a fleet management system sending or otherwise providing a notification to the customer through an email or a text message, lights which effectively identify the incorrect space may be activated to effectively provide a notification, and/or sounds or a message may be provided to effectively provide a notification. Once one or more indicators and/or notifications are provided to the customer, process flow returns to step 629 in which it is determined if the customer access the package in the correct space

Returning to step 629 and the determination of whether the customer is accessing the package in the correct space, if it is determined that the customer is accessing the correct package, the process flow proceeds to a step 641 in which it is confirmed that the package has been removed from the space assigned to the customer. Such a determination may be made in cooperation with one or more sensors, as for example a camera or a weight sensor, which may effectively detect that the package has been removed from the space assigned to the customer.

After is it confirmed that the package has been removed from the space assigned to the customer, any activated indicators are deactivated in a step 645. For example, lights associated with the space such as lights arranged to indicate that the space is assigned to the customer may be deactivated. Then, in an optional step 649, the customer may be notified that his or her delivery of the package is complete. Such a notification may, in one embodiment, include a message that is sent by a fleet management system to the customer upon the fleet management system being notified by the vehicle that the delivery of the package is complete.

Once any indicators are deactivated, and the customer is optionally notified that the delivery of his or her package is complete, the compartment door closes in a step 652. In one embodiment, computer vision or perception may be used to verify when the compartment door may be closed safely, e.g., without being impeded by the customer. Upon closing the compartment door, the vehicle may depart and the method of completing a delivery to a customer is completed.

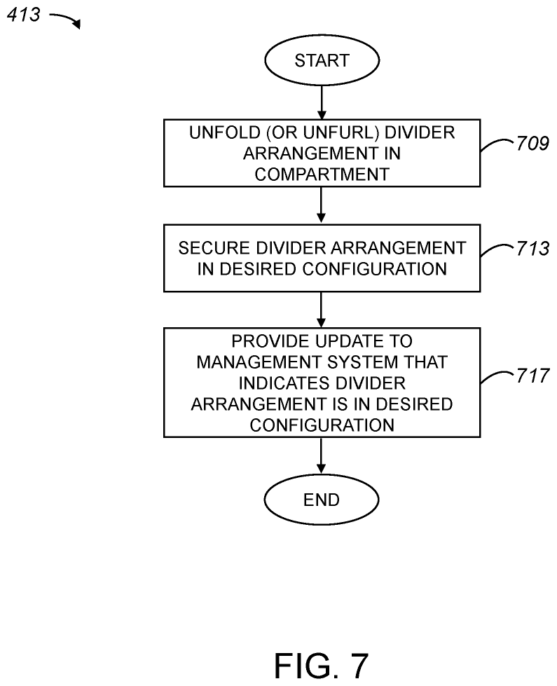

FIG. 7 is a process flow diagram which illustrates a method of deploying a divider arrangement in a compartment of a vehicle, e.g., step 413 of FIG. 4, in accordance with an embodiment. A method 413 of deploying a divider arrangement in a compartment of a vehicle begins at a step 709 in which the divider arrangement in unfolded or otherwise unfurled in the compartment. Unfolding the divider arrangement typically includes configuring the smart divider arrangement in a desired configuration. For example, the smart divider arrangement may include one or more partitions, shelves, and/or walls which may be positioned to define spaces of desired shapes and sizes. Unfurling the divider arrangement may include unrolling a divider that is stored in a rolled configuration or otherwise extending a divider that is stored in a substantially compressed configuration. In one embodiment, a process of unfolding or otherwise unfurling a divider arrangement may include transmitting or providing a divider configuration to a user who is configuring the divider arrangement, and/or indicating to the user whether the divider configuration implement by the user is correct. That is, unfolding or otherwise unfurling a divider arrangement may include providing configuration instructions and confirming, as for example using cameras and/or other sensors, that the divider arrangement is configured correctly.

In a step 713, the divider arrangement is secured in a desired configuration. Securing the divider arrangement may include fastening partitions, shelves, and/or walls of the divider arrangement to walls of the compartment or other dividers. Fastening may be accomplished using any suitable method. By way of example, fastening may include hooking a divider to a receptacle or protrusion on a wall. Once the divider arrangement is secured, an update is provided to a management system, e.g., a fleet management system, to effectively inform the management system in a step 717 that the divider arrangement is in a desired configuration. After the update is provided, the method of deploying a divider arrangement in a compartment of a vehicle is completed.

The configuration of a divider arrangement may vary widely. By way of example, a number of partitions, shelves, and/or walls associated with a divider arrangement may vary. FIG. 8 is a block diagram representation of a divider arrangement, e.g., divider arrangement 328 of FIG. 3, that is a smart divider arrangement in accordance with an embodiment. Divider arrangement 328 is generally positioned in a compartment, e.g., compartment 102 of vehicle 101 of FIG. 2. In the described embodiment, divider arrangement 328 includes at least one foldable, retractable, or compressible partition 842, a vehicle interface 844, a sensor system 846, a notification system 848, and a control system 850. That is, divider arrangement 328 is a smart divider arrangement as it includes sensor system 846, notification system 848, and control system 850.

Foldable partition 842 may generally be unfolded or deployed to define separate spaces within a compartment, or to otherwise subdivide an interior of a compartment. In one embodiment, when foldable partition 842 is in a folded or undeployed configuration, the compartment may be considered to be a substantially single, open space. Foldable partition 842 may be formed from any suitable material including, but not limited to including, a plastic material or a plastic material that is substantially wrapped in fabric, e.g., a polycarbonate material substantially covered in polyurethane.

Vehicle interface 844 includes a mounting or mechanical interface 844a that enables foldable partition 842 to be substantially secured in a desired configuration. Mechanical interface 844a may include connectors or fasteners which effectively enable foldable partition 842 to be coupled to, or otherwise engaged with, walls of the compartment. For example, mechanical interface 844a may include hinges, magnets, and/or hooks which are arranged to hold smart divider arrangement 328 against one or more walls of a compartment. Vehicle interface 844 may optionally include a power connection 844b and a network connection 844c. Optional power connection 844b may enable power to be provided to smart divider arrangement 328, as for example from a battery onboard vehicle 101 of FIGS. 2 and 3. Optional network connection 844c may be a wireless or wired connection which enables communications between smart divider arrangement 328 and a communications system of vehicle, e.g., communications system 340 of FIG. 3, and/or with a fleet management system.

Sensor system 846 includes one or more sensors configured to enable smart divider arrangement 328 to effectively monitor locations of packages, determine contents of spaces defined by foldable partition 842, and/or identify the intended recipients of packages. Sensor system 846 may include, but is not limited to including, scanners, cameras, and/or weight sensors.

Notification system 848 is configured to enable smart divider arrangement 328 to provide an indication to a customer or recipient of a package. Notification system 848 may include visual and/or audio indicators which may be activated to provide an indication of where the package of a customer is located. By way of example, notification system 848 may include one or more lights configured to illuminate or otherwise bring attention to a particular space defined by foldable partition 842 in which a package for a particular customer is located. Notification system 848 may also, or alternatively, include a speaker arrangement configured to provide an audio indication of which space the package intended for a customer is located. In one embodiment, notification system 848 may cooperate with optional network connection 844c to effectively send a message to a customer, as for example a text message or an email message, which identifies which space the package for the customer is located within.

Control system 850 is configured to manage information provided by sensor system 846 and notification system 848. By way of example, control system 850 may facilitate the transfer of information between a fleet management system and smart divider arrangement 328.

Divider arrangement 328 may be arranged to take on different configurations. For example, foldable partition 842 may be configured to define spaces of assorted sizes and shapes based upon what type of goods are to be held within the spaces. Divider arrangement 328 may be configured differently to accommodate grocery deliveries, food deliveries, and/or package deliveries.

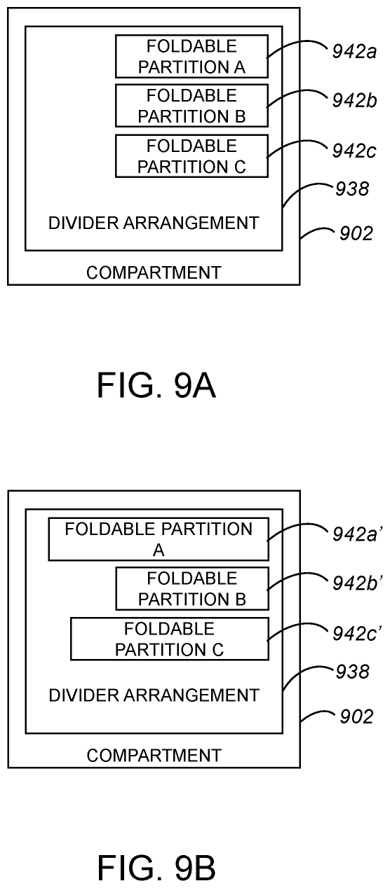

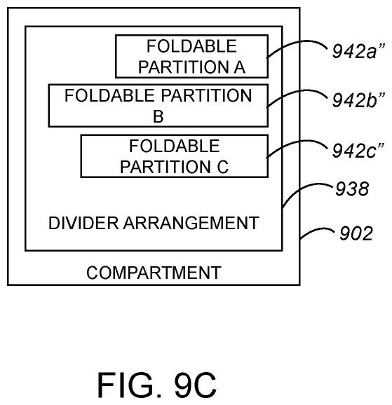

In one embodiment, a divider arrangement may be configured to support multiple configurations. That is, partitions of a divider arrangement may be deployed in different states to create different configurations of spaces. FIG. 9A is a block diagram representation of a divider arrangement in a compartment at a time t1 at which the divider arrangement is in an undeployed configuration in accordance with an embodiment. At a time t1, a compartment 902 of a vehicle contains a divider arrangement 928 which is configured in a first undeployed configuration. In a first undeployed configuration, foldable partitions 942a-c are each in a folded or otherwise undeployed orientation. By way of example, foldable partitions 942a-c may be positioned against a wall of compartment 902 such that compartment is effectively one open, interior space.

When a fleet management system receives information as to how compartment 902 is to be configured, divider arrangement 938 may be configured to effectively divide the interior space within compartment 902 into two or more separate spaces. In one embodiment, the configuration of divider arrangement 938 may vary based upon the goods to be carried within compartment 902. FIG. 9B shows divider arrangement 928 in compartment 902 at a time t2 at which divider arrangement 928 is in a first deployed configuration in accordance with an embodiment. When divider arrangement 902 is in a first deployed configuration, foldable partitions 942a′-c′ may be deployed such that foldable partitions 942a′-c′ are unfolded in a first orientation. As shown in FIG. 9C, when divider arrangement 928 in compartment 902 is configured at a time t3 in a second deployed configuration, foldable partitions 942a″-c″ may be deployed such that foldable partitions 942a″-c″ are unfolded in a second orientation.

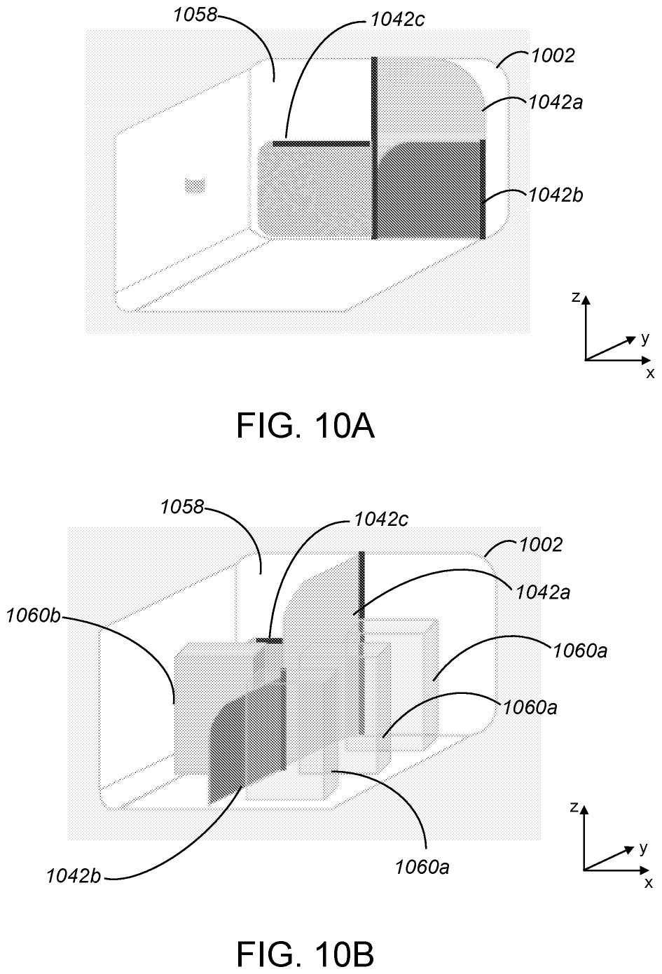

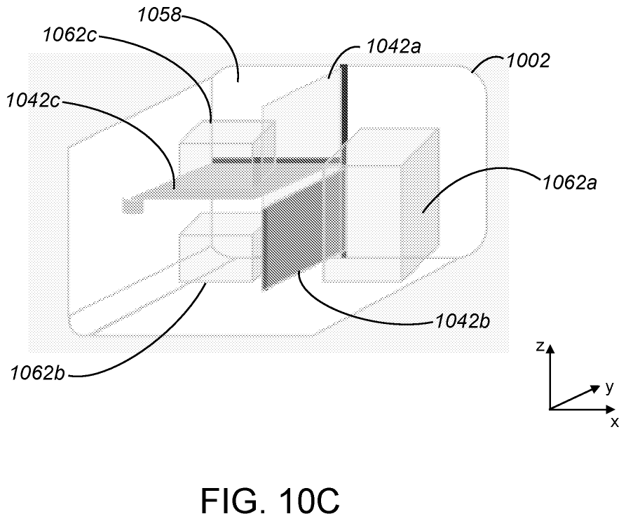

One example of a divider arrangement which may be deployed in a compartment of a vehicle will be discussed with reference to FIGS. 10A-C. FIG. 10A is a diagrammatic representation of a divider arrangement in a compartment in an undeployed configuration in accordance with an embodiment. A divider arrangement which includes partitions 1042a-c is arranged in a compartment 1002 of a vehicle. When in an undeployed state or configuration, partitions 1042a-c may effectively be positioned such that an interior of compartment 1002 is a single space. As shown, when in an undeployed configuration, partitions 1042a-c may be folded and substantially flush with a wall 1058 of compartment 1002. In the described embodiment, partitions 1042a, 1042c are coupled to wall 1058, while partition 1042b is coupled to partition 1042a, although it should be appreciated that the configuration of partitions 1042a-c while undeployed may vary widely.

Partitions 1042a-c are arranged to be deployed in one or more states or configurations. By way of example, partitions 1042a-c may be deployed to configure an interior space within compartment 1002 to accommodate specific types of deliveries. A configuration of partitions 1042a-c that are arranged to accommodate groceries, for instance, may be different from a configuration of partitions 1042a-c that are arranged to accommodate packages or parcels.

FIG. 10B is a diagrammatic representation of divider arrangement 1028a-c in compartment 1002 in a first deployed configuration in accordance with an embodiment. As shown, partitions 1042a-c may be deployed, e.g., unfolded or unfurled, such that partitions 1042a-c cooperate to extend into the interior space defined within compartment 1002 to create separate spaces or cubbies. The configuration of compartment 1002 may be suitable accommodate groceries 1060a, 1060b. Groceries 1060a may be positioned in a first space defined by partitions 1042a, 1042b, while groceries 1060b may be positioned in a second space defined by partitions 1042a, 1042b.

With reference to FIG. 10C, the deployment of partitions 1042a-c in compartment 1002 in a second deployed configuration will be described in accordance with an embodiment. Partitions 1042a-c may be deployed such that multiple individual spaces, e.g., three individual spaces, are defined in compartment 1002 to accommodate packages 1062a-c. Package 1062a may be positioned in a first space that is at least partially defined by partitions 1042a, 1042b. Package 1062b may be positioned in a second space that is at least partially defined by partitions 1042a-c, while package 1062c may be positioned in a third space that is at least partially defined by partitions 1042a, 1042c.

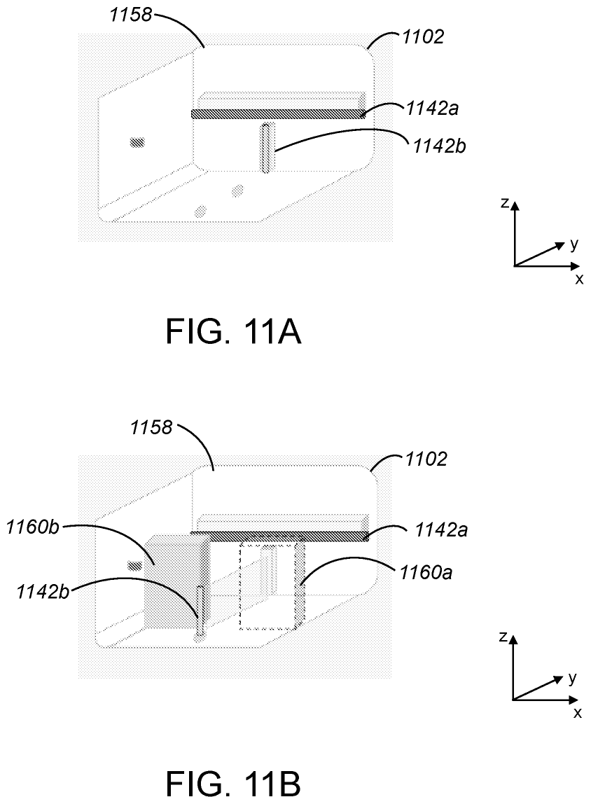

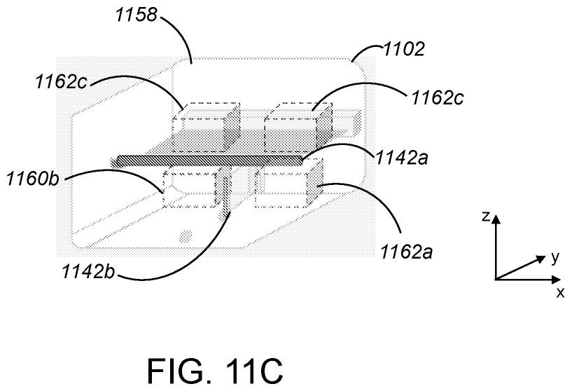

As previously mentioned, a divider arrangement may include retractable partitions which are configured to be unfurled to effectively subdivide the interior of a compartment of an autonomous vehicle. FIG. 11A is a diagrammatic representation of a retractable divider arrangement in a compartment of a vehicle in an undeployed configuration in accordance with an embodiment. A retractable divider arrangement which includes partitions 1142a, 1142b is arranged in a compartment 1102 of a vehicle. When in an undeployed state or configuration, partitions 1142a, 1142b may effectively be positioned such that an interior of compartment 1102 is essentially an undivided, single space. When in an undeployed configuration, partitions 1142a, 1142b may be retracted, e.g., rolled on a spool or reel, and may be substantially held against a wall 1158 of compartment 1102. In the described embodiment, partitions 11142a, 1142b are coupled to wall 1158.

Partitions 1142a, 1142b may be deployed, as for example extended or unfurled, to subdivide an interior space of compartment 1102 into spaces which may contain goods to be delivered. Different configurations of a subdivided interior space of compartment 1102 may be suitable for different applications such as grocery applications and package applications.

FIG. 11B is a diagrammatic representation retractable divider arrangement that includes partitions 1142a, 1142b in compartment 1102 in a first deployed configuration in accordance with an embodiment. In the embodiment as shown, partition 1142a is substantially undeployed, and partition 1142b is deployed such that the interior space within compartment 1102 is effectively divided into two separate spaces or cubbies. The configuration of compartment 1102 may be suitable accommodate groceries 1160a, 1160b. Groceries 1160a may be positioned in a first space defined by partition 1142b, while groceries 1160b may be positioned in a second space defined by partition 1142b.

Referring next to FIG. 11C, the deployment of partitions 1142a, 1142b in compartment 1102 in a second deployed configuration will be described in accordance with an embodiment. Partitions 1142a, 1142b may be deployed such that multiple individual spaces, e.g., three individual spaces, are defined in compartment 1102 to accommodate packages 1162a-c. It should be appreciated that the number of individual spaces defined may vary widely. Package 1162a may be positioned in a first space that is at least partially defined by partitions 1142a, 1142b. Package 1162b may be positioned in a second space that is at least partially defined by partitions 1142a, 1142b. Packages 1162c may be positioned in a third space that is at least partially defined by partition 1142a.

Partitions in a compartment of an autonomous vehicle may generally be provided using any suitable mechanism. By way of example, partitions may be formed using pliable surfaces that may retract onto a roller when not in use, partitions may be formed from fabrics that are configured to form slots or cubbies, partitions may be formed from substantially rigid materials that are configured to form slots or cubbies, etc. The configuration or structure of a divider arrangement, as well as the materials from which the divider arrangement may be formed, may vary widely. It should be appreciated that a divider arrangement may be part of a compartment insert that is arranged to be contained in a compartment of a vehicle.

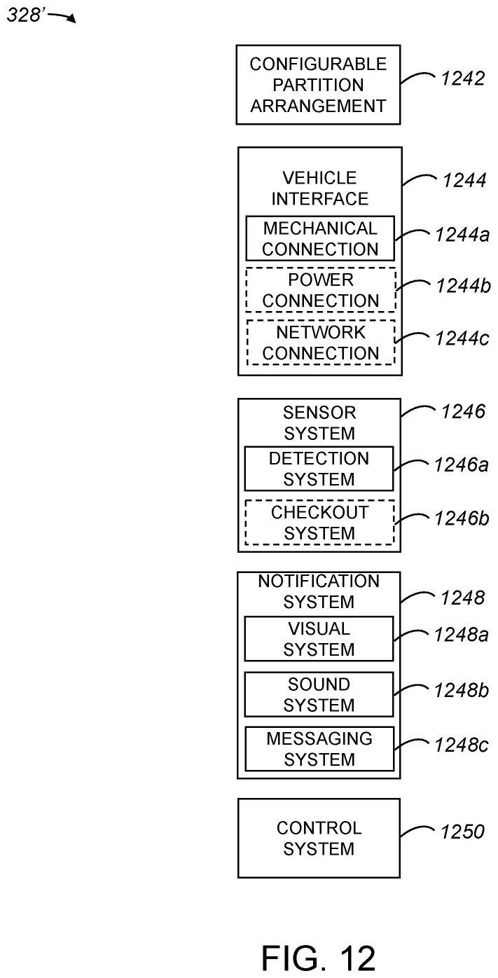

In one embodiment, a divider arrangement may be configurable in that the divider arrangement may include components which may be placed into different orientations, and/or the divider arrangement may include components which may be removed or added depending upon a desired configuration. FIG. 12 is a block diagram representation of a divider arrangement, e.g., divider arrangement 328 of FIG. 3, that includes a configurable divider arrangement in accordance with an embodiment. Divider arrangement 328′ is generally positioned in a compartment, e.g., compartment 102 of vehicle 101 of FIG. 2. Divider arrangement 328′ may be directly located in the compartment, or may be included in an insert that is arranged to occupy the compartment. In the described embodiment, divider arrangement 328′ includes at least configurable partition arrangement 1242, a vehicle interface 1244, a sensor system 1246, a notification system 1248, and a control system 1250.

Configurable partition arrangement 1242 may be configured to define separate spaces within a compartment, or to otherwise subdivide an interior of a compartment. Configurable partition arrangement 1242 may include components that are positioned within a compartment in a stored configuration when undeployed. The components may include components that are effectively coupled to a compartment or a compartment insert, as well as components that are not coupled to the compartment or the compartment insert. For example, the components may include shelves that are retractably coupled to a compartment, as well as removable divider walls that are arranged to be coupled to the shelves to substantially delineate locations in which items such as packages may be placed.

Vehicle interface 1244 includes a mounting or mechanical interface 1244a that enables configurable partition arrangement 1242 to be substantially secured in a desired configuration within a compartment or a compartment insert. Mechanical interface 1244a may include connectors, fasteners, and/or any suitable mechanism which enables configurable partition arrangement 1242 to be substantially held in a desired configuration. Vehicle interface 1244 may optionally include a power connection 1244b and a network connection 1244c. Optional power connection 1244b may enable power to be provided, as for example from a battery onboard vehicle 101 of FIGS. 2 and 3, to smart divider arrangement 328′. Optional network connection 1244c may be a wireless or wired connection which enables communications between smart divider arrangement 328′ and a communications system of vehicle, e.g., communications system 340 of FIG. 3, and/or with a fleet management system.

Sensor system 1246 includes one or more sensors configured to enable smart divider arrangement 328′ to effectively monitor locations of items, determine contents of spaces defined by configurable partition arrangement 1242, and/or identify the intended recipients of items. In the embodiment as shown, sensor system 1246 includes a detection system 1246a that includes one or more sensors configured to essentially detect the presence of items in locations or positions within smart divider arrangement 328′. Sensors included in detection system 1246a may include, but are not limited to including, a weight sensor, a scanner, a camera, a push/position sensor, a radio-frequency identification (RFID) sensor, an ultrasonic sensor, and/or a radar such as a millimeter wave lidar. Sensor system 1246 optionally includes a checkout system 1246b which may cooperate with detection system 1246b to provide an indication, as for example to an individual who removes an item from smart divider arrangement 328′, that the item has been removed and, if appropriate, cause the individual to be charged for the item.

Notification system 1248 is configured to enable smart divider arrangement 328′ to provide an indication to an individual who removes an item such as a package from smart divider arrangement 328′. Notification system 1248 may include a visual system 1248a, a sound system 1248b, and a messaging system 1248c. Visual system 1248a may include, but is not limited to including, a lighting arrangement such as light emitting diodes (LEDs) which are configured to highlight a location of an item that is intended for an individual or to otherwise provide a visual cue relating to the location of the item. Sound system 1248b may include, but is not limited to including, a recording system and a loudspeaker system which may provide an audio indication or cue which informs an individual of a location of an item intended for the individual and, additionally, may notify the individual if an incorrect item has been removed and/or if there has been an attempt to remove an incorrect item. Messaging system 1248c may be a system which enables a message, e.g., a text message or an email message, to be sent to an individual to notify the individual of a location of an item intended for the individual.

Control system 1250 is configured to manage information provided by sensor system 1246 and notification system 1248. By way of example, control system 1250 may facilitate the transfer of information, such as information relating to a status of items carded by smart divider arrangement 328′, between a fleet management system and smart divider arrangement 328′. It should be appreciated that when communication with a fleet management system, control system 1250 may engage in wireless communications with a server or computing system associated with the fleet management system.

A configurable partition arrangement 1242 may generally be arranged within a compartment of a vehicle, and may take any suitable configuration. For example, configurable partition arrangement 1242 may include shelves which are substantially segmented into separate areas, or configurable partition arrangement 1242 may be arranged to define slots or niches.

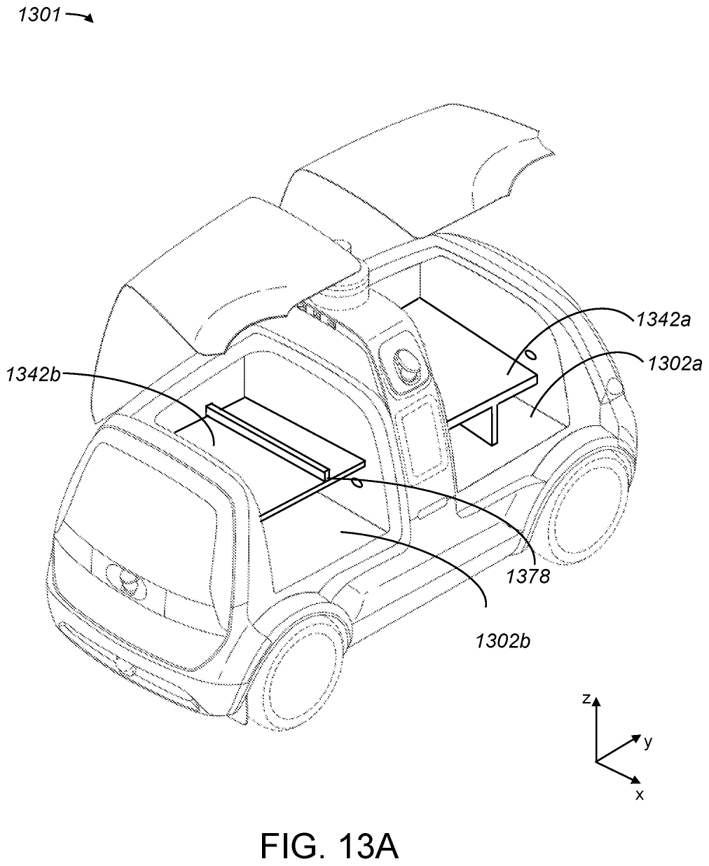

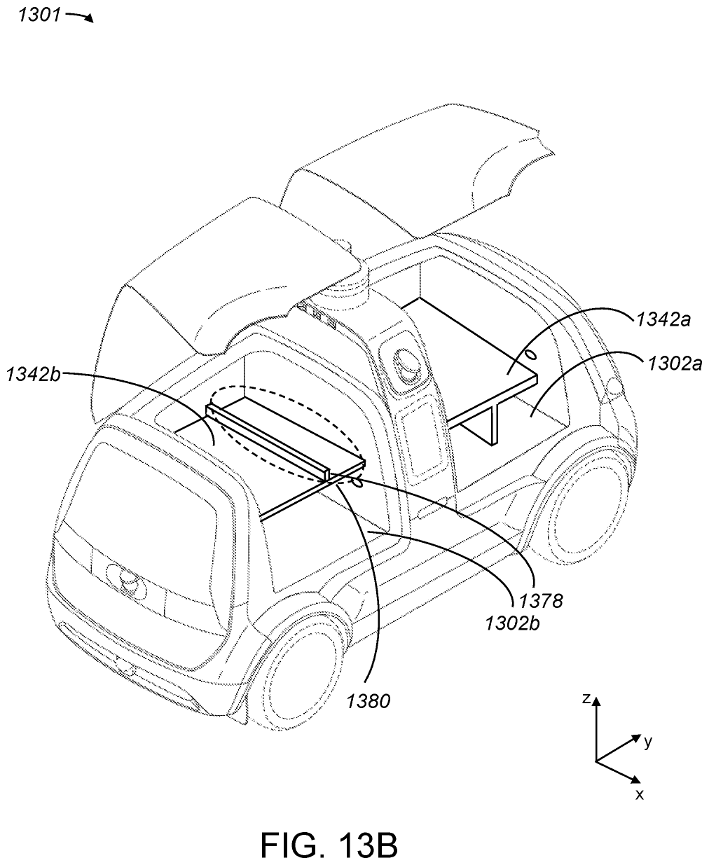

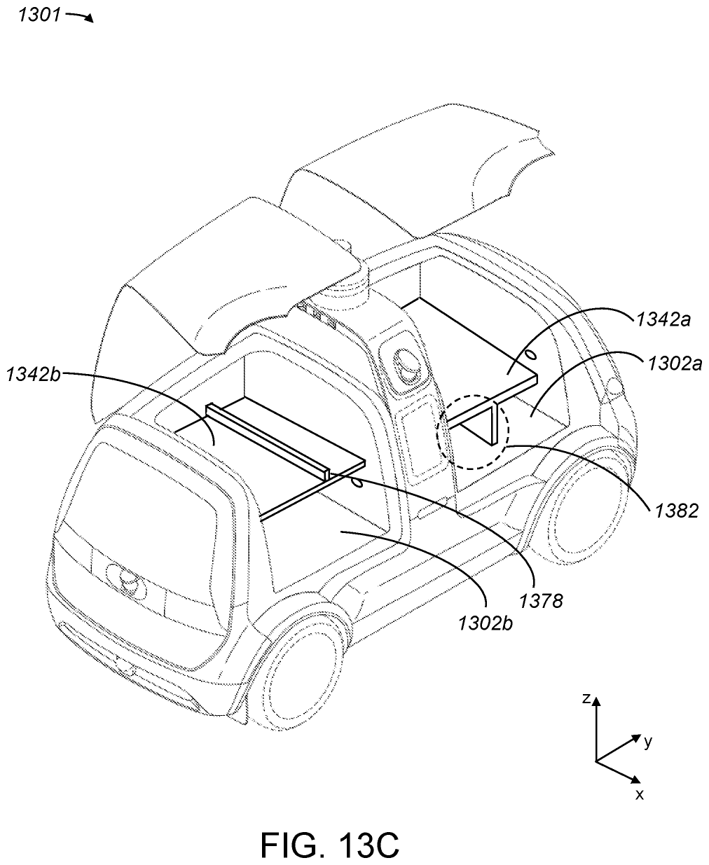

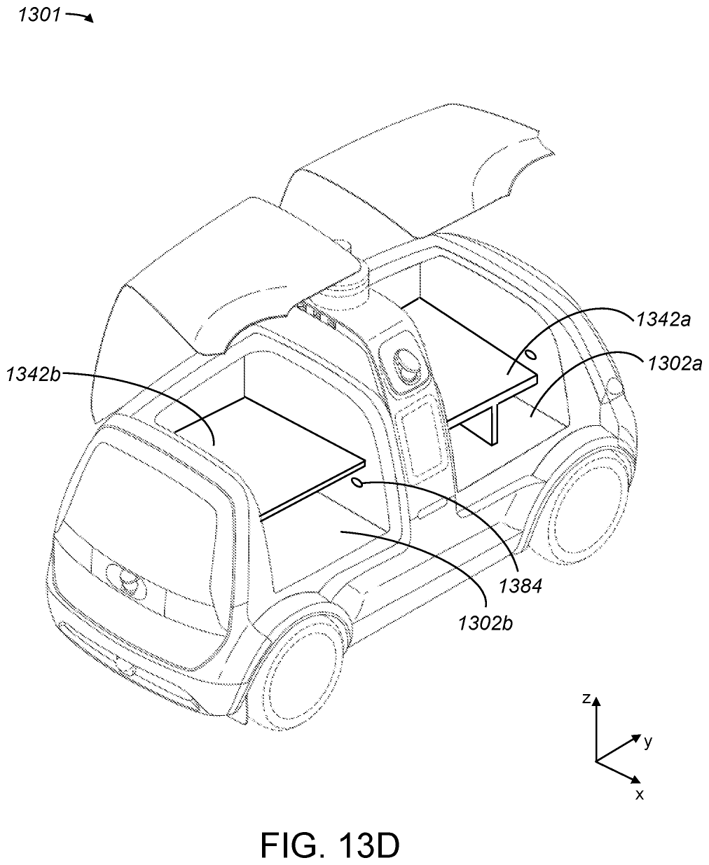

With reference to FIGS. 13A-D, a vehicle which includes compartments arranged to accommodate configurable divider or partition arrangements with be described in accordance with embodiments. FIG. 13A is a diagrammatic representation of a vehicle with compartments that are configured to include configurable partition arrangements in accordance with an embodiment. A vehicle 1301 includes a first compartment 1302a and a second compartment 1302b that are arranged to accommodate items or goods. In the embodiment as shown, first compartment 1302a includes a first configurable partition arrangement 1342a, and second compartment 1302b includes a second configurable partition arrangement 1342b. Second configurable partition arrangement 1342b includes a bar or beam 1378 which essentially creates a partitioned space on an upper surface of second configurable partition arrangement 1342b.

Items may be located in compartments 1302a, 1302b in locations or spaces defined by partition arrangements 1342a, 1342b, respectively. In order to indicate to an individual, e.g., a recipient or a customer, where an item the individual is to retrieve is located, the location may be highlighted. As previously mentioned, lights or other sources of illumination may be used to essentially highlight the location or spot.

FIG. 13B shows a first delivery spot that may be substantially highlighted in accordance with an embodiment. As shown, a first delivery spot 1380 is at least partially defined by bar 1378 as part of partition arrangement 1342b. When an item that is to be retrieved is positioned in spot 1380, spot 1382 may be highlighted or illuminated to draw the attention of an individual to spot 1380.

FIG. 13C shows a second delivery spot that may be substantially highlighted in accordance with an embodiment. A second delivery spot 1382 is defined as a part of partition arrangement 1342a. When an item that is to be retrieved is position in spot 1382, spot 1382 may be highlighted, e.g., using lighting or another visual indicator. In one embodiment, highlighting may also be accomplished using an audio indication such as an announcement of where spot 1382 is within partition arrangement 1342a.

The configurations of partition arrangements 1342a, 1342b may be altered to accommodate particular items to be transported by vehicle 1301. For example, when a larger location or spot may be needed to accommodate an item in compartment 1302b, partition arrangement 1342b may be altered by removing bar 1378, as shown in FIG. 13D. When bar 1378 is removed, an upper or top surface associated with partition arrangement 1342b may accommodate a larger item than may be accommodated when bar 1378 is in place.

In addition to changing the configurations of partition arrangements 1342a, 1342b to accommodate items of varying sizes, the configuration may also be changed for other reasons. By way of example, the configurations may be changed to facilitate the display of items and/or the facilitate the removal of items. Partition arrangement 1342b may, for example, engage a fastener 1384 in the event that the upper surface associated with partition arrangement 1342b is to be substantially sloped or otherwise positioned at an angle.

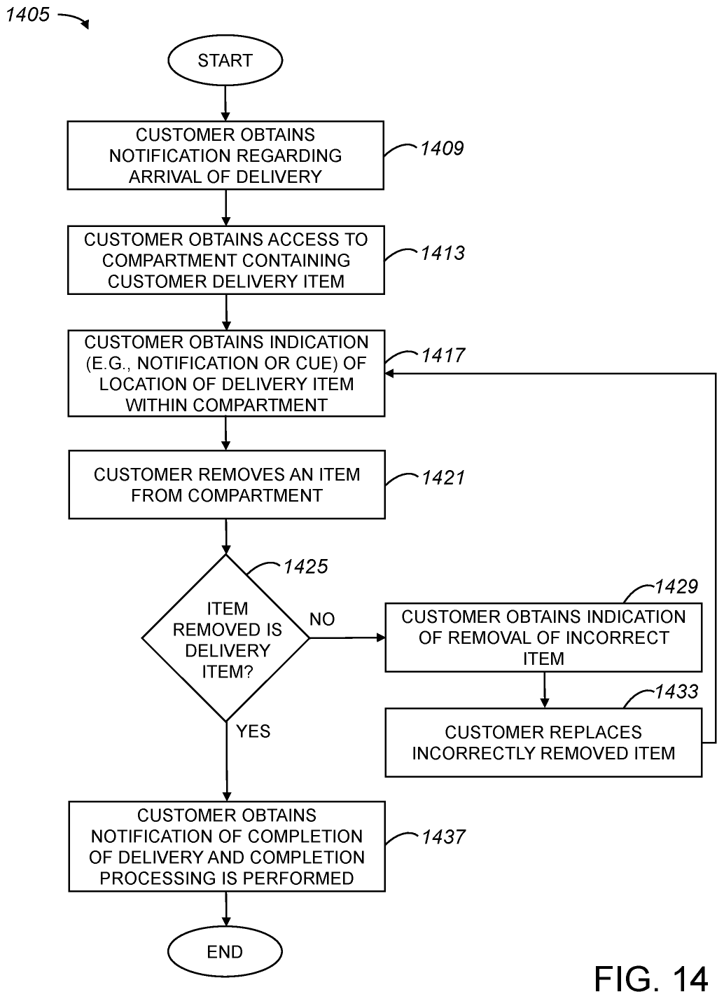

Referring next to FIG. 14, a method of a customer obtaining a delivery from a vehicle with a compartment which includes a smart divider arrangement will be described in accordance with an embodiment. A method 1405 of a customer obtaining a delivery from a vehicle begins at a step 1409 in which the customer obtains a notification regarding the arrival of a customer delivery on a delivery vehicle. The customer may be notified through any suitable method including, but not limited to including, receiving a text message, receiving an email message, receiving a status update indication in a software application which tracks the customer delivery, receiving a phone call, and/or hearing an audio indication emitted by the delivery vehicle.

Once the customer obtains a delivery notification, the customer obtains access to the compartment on the delivery vehicle that contains the customer delivery item in a step 1413. The customer may be authenticated by the delivery vehicle and/or a management system associated with the delivery vehicle. Access to the compartment may be provided when the customer is authenticated, e.g., a door to the compartment may be unlocked and/or opened.

In a step 1417, the customer is effectively notified of the location within the compartment of the customer delivery item. The customer may receive a message, or a smart divider system in the compartment may provide a visual cue and/or an audio cue which indicates to the customer where the customer delivery item is located or positioned. A visual cue may involve utilizing lights and/or a display screen to illuminate or to otherwise call out the location of the customer delivery item. An audio cue may utilize a speaker onboard the delivery vehicle to substantially announce the location of the customer delivery item.

After the customer is notified of a location of the customer delivery item, the customer removes or otherwise retrieves an item from the compartment in a step 1421. A determination is made in a step 1425 as to whether the item that was removed by the customer is the customer delivery item, or the item intended for the customer. That is, it is determined whether the customer has removed the correct item, i.e., the customer delivery item.

If the determination in step 1425 is that the item removed by the customer is the customer delivery item, the implication is that the delivery to the customer is successfully completed. Accordingly, in a step 1437, the customer obtains a notification regarding the completion of the delivery, and completion processing is performed. Completion processing may include, but is not limited to including, providing an indication to a fleet management system that the location from which the item was removed is free or otherwise available and/or effectively rescinding access to the compartment. The method of a customer obtaining a delivery from a vehicle is then completed.

Returning to step 1425, if it is determined that the item removed by the customer is not the item intended for the customer, then in a step 1429, the customer obtains an indication of the removal of an incorrect item. Such an indication may include, but is not limited to including, highlighting or continuing to highlight the location of the customer delivery item, providing an audio reminder of the location of the customer delivery item, and/or sending a message to the customer.

After the customer obtains an indication of the removal of an incorrect item, the customer replaces the incorrectly removed item in a step 1433. In one embodiment, the item that the customer substantially places in the location previously occupied by the incorrect item may effectively be verified to be the incorrect item. Such a verification may involve capturing a video using one or more sensors and allowing the video to be viewed, e.g., by a teleoperator, to substantially confirm that the incorrectly removed item has been replaced. From step 1433, process flow returns to step 1417 in which the customer continues to obtain an indication of the location of the customer delivery item.

A vehicle which includes a smart divider arrangement may be dispatched to pick up items from a customer. For example, a customer may request that a vehicle pick up an item that the customer may be returning to a vendor or seller, or the customer may request that a vehicle pick up a parcel or package for delivery to a particular location.

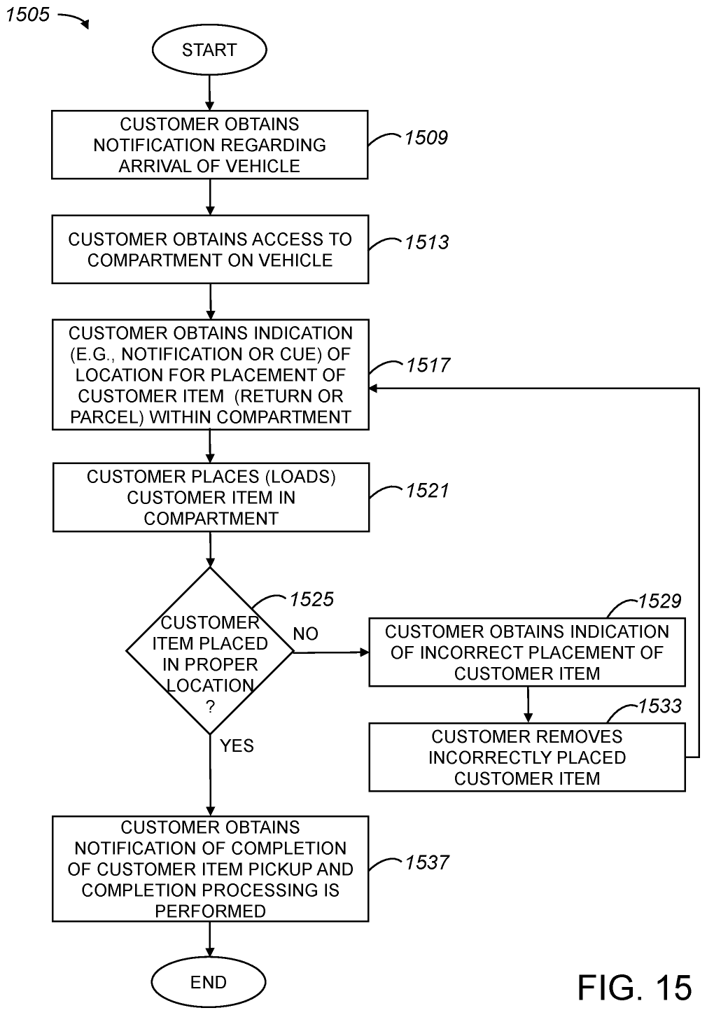

FIG. 15 is a process flow diagram which illustrates a method of a customer providing an item, as for example a return item or a parcel, to a compartment of a vehicle which includes a smart divider arrangement in accordance with an embodiment. A method 1505 of providing an item to a vehicle with at least one compartment that includes a smart divider arrangement begins at a step 1509 in which a customer obtains a notification regarding the arrival of a vehicle. The vehicle, which may be an autonomous vehicle, may have been proactively requested by the customer, or the vehicle may have been dispatched by an enterprise upon obtaining information regarding an item that is to be picked up. The notification may be provided to the customer as a message such as an email message, a text, a message in a software application, and/or a phone call. The notification may also, or alternatively, effectively be provided to the customer using sounds emitted by the vehicle, e.g., from a horn and/or a speaker, upon arrival at a location associated with the customer.

In a step 1513, the customer obtains access to a compartment on the vehicle. The customer may undergo an authentication process, using a software application, with either the vehicle or an enterprise associated with the vehicle prior to being granted access to the compartment. The vehicle may open a door to the compartment, or otherwise provide access to the compartment, upon completion of the authentication process.

Once the customer obtains access to the compartment on the vehicle, the customer obtains an indication of a location for the placement of the customer item within the compartment in a step 1517. The indication may be obtained through a message sent to the customer, as for example a text message or an email message, and/or through a visual and/or audio cue. A visual cue may include, but is not limited to including, utilizing lights or a display screen associated with a smart divider arrangement to substantially highlight the location, or position with respect to a divider arrangement, at which the customer item is to be placed. In one embodiment, highlighting the location at which the customer is to place the customer item may include utilizing one or more light structures to illuminate or otherwise use light to highlight the location.

After the customer obtains an indication of the location for the placement of the item, the customer places or loads the customer item into the compartment at a step 1521. A determination is then made at a step 1525 as to whether the item has been placed in the proper location, e.g., the location associated with the notification obtained by the customer. Sensors in the compartment may be used to determine whether the customer item has been placed in the expected location.

If the determination in step 1525 is that the customer item has been placed in the proper location, then process flow proceeds to a step 1537 in which the customer is notified of the completion of the customer item pickup process. Typically, when the pickup process is completed, completion processing may be performed. Completion processing may include, but is not limited to including, providing an indication to a fleet management system that the location from which the item was removed is free or otherwise available and/or effectively rescinding access to the compartment. Once the customer obtains a notification that the pickup process is completed, the method of providing an item to a vehicle with at least one compartment that includes a smart divider arrangement is completed.

Alternatively, if it is determined in step 1525 that the customer has not placed the customer item in the proper or expected location, the customer obtains an indication of the incorrect placement in a step 1529. In one embodiment, the a visual cue or an audio cue may be provided by the vehicle. A visual cue may involve highlighting the proper location by increasing the intensity of a light if the proper location is already highlighted, flashing the light, etc. An audio cue may involve a speaker which broadcasts a message informing the customer of the current location for the customer item.

In a step 1533, the customer removes the incorrectly placed customer item from the location or position at which the customer item was placed. Then, process flow returns to step 1517 in which the customer obtains or continues to obtain an indication of the proper location for the placement of the customer item with respect to the smart divider arrangement.

Although only a few embodiments have been described in this disclosure, it should be understood that the disclosure may be embodied in many other specific forms without departing from the spirit or the scope of the present disclosure. By way of example, a divider arrangement has been described as using a sensor system and a notification system. The sensor system and the notification system may be part of the divider arrangement, or a sensor system and a notification system may instead be part of the vehicle. In one embodiment, a divider arrangement may include some sensors and also leverage other sensors that are part of the vehicle. That is, a divider arrangement may use sensors and/or a notification system that are not part of the divider arrangement in conjunction with sensors and/or a notification that is part of the divider arrangement. Sensors such as cameras positioned in a compartment may be used, in one embodiment, to identify a package, identify a location of the package, and/or identify a disposition of the package. Such sensors may cooperate with a notification system of a divider system to provide a visual or audio indication of the location of a package.

The number of partitions included in a divider arrangement, as well as the number of individual spaces which may be defined by partitions of a divider arrangement, may vary widely. The orientation of partitions may also vary widely.

The configuration of a divider arrangement may vary widely. For example, in lieu of, or in addition to, defining spaces, a divider arrangement may include hooks, latches, and/or other mechanisms which enable bags to be suspended therefrom. The bags may be arranged to contain goods such as packages to be delivered to customers. For example, a bag that contains a package to be delivered to a customer may be suspended from a hook, and arranged such that the customer may unhook the bag from the hook in order to retrieve his or her package. In one embodiment, a hook may include a locking mechanism that is electronically controlled such that the locking mechanism substantially only unlocks for an appropriate customer.

To facilitate the deployment of partitions of a divider arrangement, partitions may be movably coupled or otherwise attached to a surface, e.g., a wall or a floor, of a compartment. Partitions may be, but are not limited to being, rotatably or pivotably attached to a surface of a compartment, translationally attached to a surface of a compartment, retractably attached to a surface of a compartment, and/or removably attached to a surface of a compartment without departing from the spirit or scope of the disclosure.

In one embodiment, a divider arrangement may be arranged to substantially retract into a floor of a compartment or a bottom surface of a compartment insert that is arranged to be placed into the compartment. For example, the divider arrangement may include a relatively rigid top surface and slots beneath the rigid top surface that are formed from a fabric such that when the divider arrangement is retraced into a floor or a bottom surface, the fabric effectively folds beneath the relatively rigid top surface. Alternatively, a divider arrangement may include horizontal shelves that may be arranged to be stored on a floor or a bottom surface of a compartment, and may be substantially individual placed into desired positions within the compartment to form slots into which items may be placed.

When a vehicle is to be used to pick up or to procure packages, a divider arrangement in a compartment may indicate where packages are to be loaded, or indicators associated with the compartment may indicate where packages are to be loaded. In one embodiment, when a compartment into which a package is to be loaded does not contain any other packages or goods, instructions may be provided to an individual who is about to load the package into the compartment which indicate how to configure the divider arrangement to efficiently accommodate the package being loaded. Such instructions may be provided using any suitable method, e.g., in a message sent to the individual who is loading the package.

A single location included in a smart divider arrangement may accommodate more than one item. For example, one slot in a smart divider arrangement may hold two or more packages. When such packages are intended for a single recipient, a delivery is not identified as being complete until both packages are no longer detected in the slot. On the other hand, when such packages are intended for more than one recipient, sensors associated with the smart divider arrangement may be used to determine when one of the packages is removed and whether the correct package was removed.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. By way of example, although a package or item has generally been described as being scanned to obtain information prior to placing the package into a space or a location in a smart divider arrangement, the package or item may instead be placed into the space or the location before being scanned. Therefore, the present examples are to be considered as illustrative and not restrictive, and the examples are not to be limited to the details given herein, but may be modified within the scope of the appended claims.

What is claimed is:

1. A vehicle comprising:
a chassis;
a propulsion system supported by the chassis, the propulsion system configured to propel the vehicle;
a control system supported by the chassis, the control system configured to enable the vehicle to operate autonomously;
at least one compartment supported by the chassis; and
at least one configurable divider arrangement contained within the at least one compartment, the at least one configurable divider arrangement arranged to define at least a first location, wherein the at least one configurable divider arrangement includes a sensor system and a notification system, the sensor system being arranged to detect a presence of an item at the first location, the notification system being arranged to provide an indication relating to the first location.

2. The vehicle of claim 1 wherein the notification system includes a visual system and the indication includes a visual indication of the first location, the visual system being arranged to provide the visual indication of the first location.

3. The vehicle of claim 1 wherein the notification system includes a sound system and the indication includes an audio indication relating to the first location, the sound system being arranged to provide the audio indication of the first location.

4. The vehicle of claim 3 wherein the sound system is arranged to provide the audio indication of the first location broadcasting a message which identifies the first item as being present as the first location.

5. The vehicle of claim 1 wherein the at least one configurable divider arrangement has a retracted state and a deployed state, wherein the at least one configurable divider arrangement is arranged to define at least the first location when the at least one configurable divider arrangement is in the deployed state.

6. The vehicle of claim 5 wherein at least one configurable divider arrangement includes one surface configured to include at least the first location when the at least one configurable divider arrangement is in the deployed state.

7. The vehicle of claim 1 wherein the sensor system includes at least one selected from a group including a weight sensor system, a scanner system, and a camera.

8. An apparatus comprising:
a configurable partition arrangement, the configurable partition arrangement having at least one deployed configuration and a retracted configuration, wherein the configurable partition arrangement is arranged to define at least a first location when in the at least one deployed configuration;
an interface, the interface including a connection, the connection configured to couple the configurable partition arrangement to a vehicle;
a sensor system; the sensor system being arranged to detect a presence of an item at the first location; and
a notification system, the notification system being arranged to provide an indication that identifies the first location.

9. The apparatus of claim 8 wherein the sensor system includes at least one selected from a group including a weight sensor system, a scanner system, and a camera.

10. The apparatus of claim 8 wherein the indication is a visual indication, and the notification system is arranged to provide the visual indication by visually highlighting the first location.

11. The apparatus of claim 8 wherein the indication is an audio indication, and the notification system is arranged to provide the audio indication by broadcasting a message what identifies the first location.

12. The apparatus of claim 8 further including:
a control system, the control system being arranged to enable the apparatus to communicate with a fleet management system.

13. A method comprising:
supporting a first item at a first location defined in a configurable divider arrangement when the configurable divider arrangement is in a first orientation, the configurable divider arrangement being arranged in a first compartment on a vehicle;
providing access to the first compartment;
providing, using a notification system included in the first compartment, a first indication of the first location;
determining when the first item is removed from the first location; and
providing, using the notification system, a completion indication when it is determined that the first item is removed from the first location, the completion indication being arranged to indicate that the first item is removed from the first location.

14. The method of claim 13 wherein the first item is intended for a recipient and the configurable divider arrangement defines a second location, and the method further includes:
supporting a second item at the second location.

15. The method of claim 14 wherein when it is determined that the first item is not removed from the first location, the method further includes:
determining whether the second item has been removed; and
providing, using the notification system, a second indication when it is determined that second item has been removed, wherein the second indication is arranged to identify the first location.

16. The method of claim 15 wherein the second indication is further arranged to indicate that the second item is not intended for the recipient.

17. The method of claim 16 wherein the second indication includes at least one selected from a group including a visual indication and an audio indication.

18. The method of claim 13 wherein the notification system is included in the configurable divider arrangement.

19. The method of claim 13 wherein the first orientation is a first deployed orientation, and wherein configurable divider arrangement includes a retracted orientation, the method further including:
changing a configuration of the configurable divider arrangement from the retracted orientation to the first deployed orientation before supporting the first item at the first location.

20. The method of claim 13 wherein the vehicle is an autonomous vehicle.
